(19) United States
(12) Patent Application Publication
(10) Pub. No.: US 2024/0307898 A1
(43) Pub. Date: Sep. 19, 2024

(54) FLUID DISCHARGE DEVICE

(71) Applicant: BRILLIAN NETWORK & AUTOMATION INTEGRATED SYSTEM CO., LTD., Miaoli County (TW)

(72) Inventors: Yu-Pao CHEN, Miaoli County (TW); Nian-Zu YANG, Miaoli County (TW); Sheng-Chi HSU, Miaoli County (TW)

(21) Appl. No.: 18/141,679

(22) Filed: May 1, 2023

(30) Foreign Application Priority Data
Mar. 13, 2023 (TW) 112109235

(51) Int. Cl. B05B 1/20; F16K 47/10

(52) U.S. Cl. CPC B05B 1/205; F16K 47/10

(57) ABSTRACT

A fluid discharge device includes a hollow tubular body. The hollow tubular body defines a flow channel and has a plurality of bore holes arranged along a longitudinal direction of the hollow tubular body. The hollow tubular body includes a plurality of sections, two adjacent sections of the plurality of sections are connected by a choke ring, and the choke ring has an opening to allow a fluid to pass through. In a sectional plane perpendicular to the longitudinal direction, a sectional area of the opening is smaller than a sectional area of the flow channel.

### CROSS-REFERENCE TO RELATED APPLICATION

This application claims the priority benefit of Taiwan application no. 112109235, filed Mar. 13, 2023. The entirety of the above-mentioned patent application is hereby incorporated by reference herein and made a part of this specification.

### BACKGROUND

### Field of the Invention

The invention relates to a fluid discharge device, and more particularly to a fluid discharge device capable of discharging fluid at a uniform speed.

### Description of the Related Art

Currently, a fluid discharge device that uses multiple nozzles on a tubular body to discharge fluid often has the problem of uneven discharge speeds. For example, as shown in FIG. 1A, an elongated tube 10 may include a middle section and two side sections respectively on two sides of the middle section. If fluid enters the elongated tube 10 via both ends and is discharged by multiple bore holes 12 provided on the wall of the elongated tube 10, an average discharge speed of fluid discharged by bore holes 12 in a middle section is greater than an average discharge speed of fluid discharged by bore holes 12 in each side section, where the magnitudes of discharge speeds are represented by lengths of arrows as shown in FIG. 1A. Therefore, this results in uneven discharge speeds throughout the elongated tube 10. Furthermore, as shown in FIG. 1B, when one end of the elongated tube 10 is closed and fluid enters the elongated tube 10 only via the other end, an average discharge speed of the fluid discharged by bore holes 12 near the closed end 14 is greater than an average discharge speed of the fluid discharged by bore holes 12 away from the closed end 14, where the magnitudes of discharge speeds are represented by lengths of arrows as shown in FIG. 1B. This similarly results in uneven discharge speeds throughout the elongated tube 10. Therefore, it is desirable to provide a fluid discharge device capable of discharging fluid at a uniform speed to solve the above problems.

### BRIEF SUMMARY OF THE INVENTION

According to one aspect of the invention, a fluid discharge device includes a hollow tubular body, and the hollow tubular body defines a flow channel and has a plurality of bore holes arranged along a longitudinal direction of the hollow tubular body. The hollow tubular body includes a plurality of sections, two adjacent sections of the plurality of sections are connected by a choke ring, and the choke ring has an opening to allow a fluid to pass through. In a sectional plane perpendicular to the longitudinal direction, a sectional area of the opening is smaller than a sectional area of the flow channel.

According to another aspect of the invention, a fluid discharge device includes a hollow tubular body defining a flow channel, a first choke ring, and a second choke ring. The hollow tubular body includes a first section, a second section and a third section, the second section is located between the first section and the third section, and each of the first section, the second section, and the third section has a plurality of bore holes. The first choke ring connects the first section with the second section, and the first choke ring is capable of reducing a flow rate of a fluid when the fluid flowing in the first section runs into the second section. The second choke ring connects the second section with the third section, and the second choke ring is capable of reducing a flow rate of the fluid when the fluid flowing in the third section runs into the second section.

Based on the above, a choke ring capable of reducing the flow rate of fluid passing therethrough is used to uniform the fluid discharge amount and the discharge speed of different sections of a flow channel, and thus cause the bore holes in different positions of a fluid discharge device to release fluid at similar speeds to be suitable for use in different application environments. For example, the fluid may be a liquid or a gas. The liquid may be, for example, water, aqueous solution, a photoresist, a developer or a cleaning agent that can be used in different processes as a working fluid, and multiple bore holes of a fluid discharge device can evenly spray the liquid onto a workpiece at a uniform speed. The gas may be, for example, compressed air or inert gas, and the fluid discharge device can blow the gas out of the bore holes disposed along the entire channel at similar speeds to meet various working requirements. Moreover, in the above embodiments, the number of choke rings, shapes and sizes of holes/openings, and spacing of bore holes can be adjusted according to the required discharge speed distribution in different regions to further improve the uniformity of fluid discharge speed. Additionally, the opening of a choke ring can be provided with an expanded portion to locally adjust the flow rate and prevent excessive speed changes around the choke ring.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1A and FIG. 1B show schematic diagrams of conventional fluid discharge devices.

FIG. 2A shows a schematic diagram of a fluid discharge device according to an embodiment of the invention, and FIG. 2B is a schematic diagram showing multiple bore holes provided on a hollow tubular body of the fluid discharge device.

FIG. 3 shows a schematic diagram of a choke ring according to an embodiment of the invention, and FIG. 4 is a schematic cross-section of the choke ring showing the positional relationship of an opening of the choke ring relative to the hollow tubular body.

FIG. 5A shows a schematic cross-section of a choke ring with an opening according to an embodiment of the invention, and FIG. 5B shows a schematic cross-section of a choke ring with an opening according to another embodiment of the invention.

FIG. 6 shows a schematic diagram illustrating an arrangement of bore holes according to an embodiment of the invention.

FIG. 7 shows a schematic diagram illustrating different test positions for measuring discharge speeds according to an embodiment of the invention.

FIG. 8 shows a schematic diagram of a fluid discharge device according to another embodiment of the invention

FIG. 9 shows a schematic diagram of a fluid discharge device according to another embodiment of the invention

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

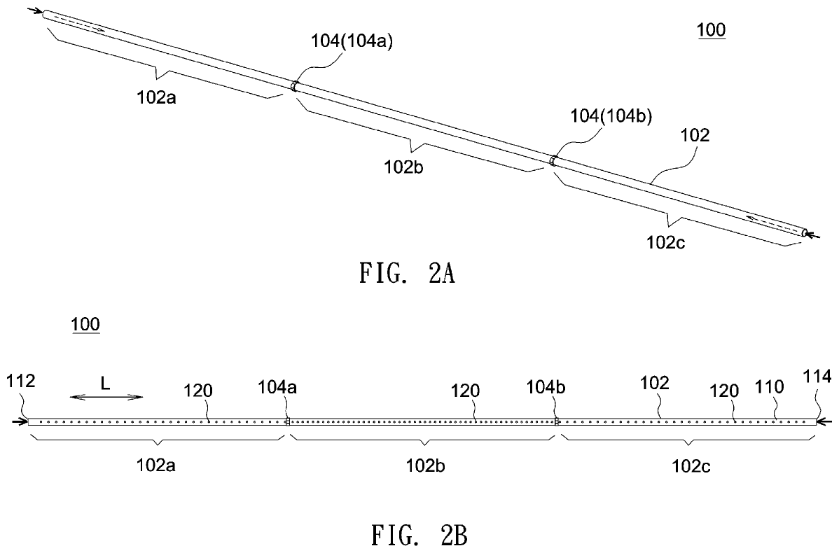

FIG. 2A shows a three-dimensional schematic diagram of a fluid discharge device according to an embodiment of the invention, and FIG. 2B is a schematic diagram showing multiple bore holes provided on a hollow tubular body of the fluid discharge device. As shown in FIG. 2A, the fluid discharge device 100 includes a hollow tubular body 102 and multiple choke rings 104 (FIG. 2A shows two choke rings 104a and 104b). The hollow tubular body 102 includes sections 102a, 102b and 102c, and the section 102b is located between the section 102a and the section 102c. The adjacent sections 102a and 102b are connected by a choke ring 104a, and the adjacent sections 102b and 102c are connected by a choke ring 104b. Each choke ring 104 may connect two adjacent sections of the tubular body 102 by various methods without limitation such as welding, fastening, or adhesive bonding to form a long hollow tubular body 102 having a desired length. Alternatively, the choke ring 104 may be formed directly by protrusions protruding from an inner wall of the tubular body 102.

In this embodiment, as shown in FIG. 2B, the wall of the hollow tubular body 102 defines a flow channel 110, and the flow channel 110 has two inlets 112 and 114 at opposite ends of the hollow tubular body 102. Multiple bore holes 120 are arranged on the hollow tubular body 102 along a longitudinal direction L of the hollow tubular body 102. Fluid enters the flow channel 110 via the left inlet 112 and the right inlet 114, flows through the entire hollow tubular body 102, and is discharged via the bore holes 120 of the hollow tubular body 102. The aperture, shape, spacing, and arrangement of the bore holes 120 may vary according to actual needs without limitation.

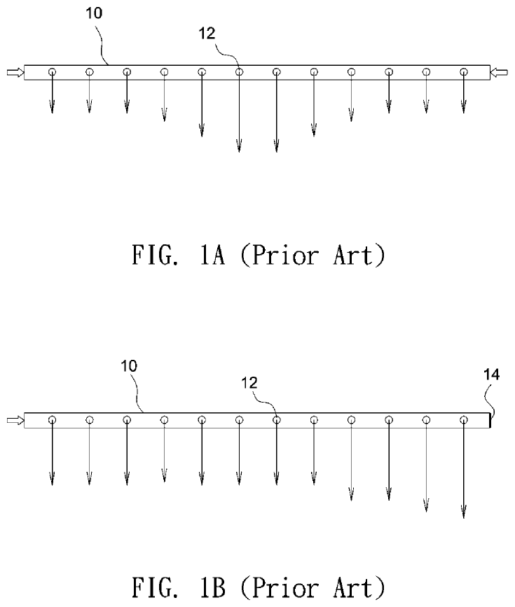

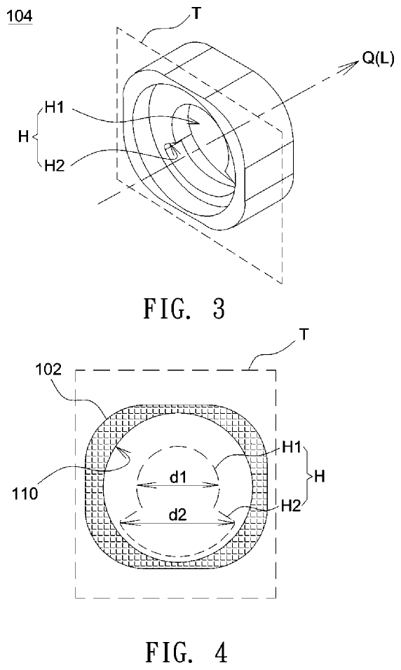

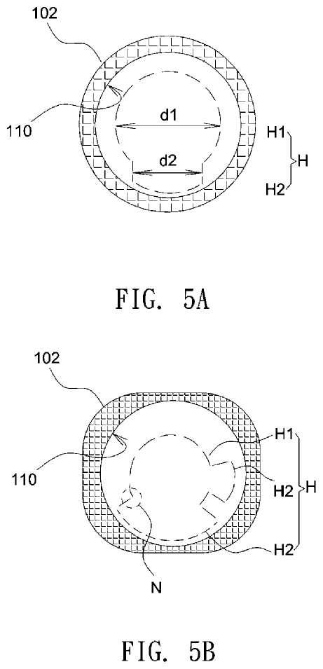

FIG. 3 shows a schematic diagram of a choke ring according to an embodiment of the invention, and FIG. 4 is a schematic cross-section of the choke ring showing the positional relationship of an opening of the choke ring relative to the hollow tubular body. Referring to both FIG. 3 and FIG. 4, in this embodiment, the choke ring 104 has an opening H for fluid to pass through. In a cross-section T perpendicular to a flow direction Q (the longitudinal direction L), a sectional area of the opening H (an area enclosed by the dashed lines marked as H1 and H2 in FIG. 4) is smaller than a sectional area of the flow channel 110 of the hollow tubular body 102 (an area enclosed by the circle marked as 110 in FIG. 4). Therefore, when fluid in the hollow tubular body 102 flows through the choke ring 104, the choke ring 104 may block part of the fluid flow because the sectional area of the opening H of the choke ring 104 is smaller than the sectional area of the flow channel 110. Referring to FIG. 1B again, in this embodiment, choke rings 104a and 104b are respectively provided on the left side and the right side of the tubular body 102. Therefore, the choke ring 104a is capable of reducing the flow rate when fluid flowing in the section 102a runs into the middle section 102b, and the choke ring 104b is capable of reducing the flow rate when fluid flowing in the section 102c runs into the middle section 102b. This results in a decrease in the discharge speed of fluid released by the bore holes 102b of the middle section 102b. Thereby, the discharge speed of fluid among different sections of the tubular body 102 can be closer, thus achieving the effect of uniformly discharging fluid by the fluid discharge device 100. Furthermore, as shown in FIG. 3 and FIG. 4, in this embodiment, the opening H may include a central portion H1 and an expanded portion H2 extending from the central portion H1 to the bore holes 120. The expanded portion H2 may function to locally enlarge the opening H. In this embodiment, because the sectional flow area in the flow channel may suddenly decrease due to the choke rings 104a and 104b, the fluid discharge amount and flow rate of the middle section 102b at some positions closest to the choke rings 104a and 104b may abruptly decrease to result in an uneven distribution of discharge speeds. Therefore, by locally enlarging the opening H through the expanded portion H2, the sudden decrease in the fluid discharge amount can be balanced to solve the above problem and further uniform the discharge speed of the fluid discharge device 100. In this embodiment, a maximum interval d2 of the expanded portion H2 can be greater than a maximum interval d1 of the central portion H1, where the maximum interval is defined as a maximum distance between any two points of the expanded portion H2 or any two points of the central portion H1. Preferably, the expanded portion H2 in the cross-section T is in a position near the bore hole 120; that is, when the bore holes 120 are arranged on the bottom of the hollow tubular body 102, the expanded portion H2 inside the choke ring 104a is disposed near the bottom of the hollow tubular body 102. It should be noted that, in various embodiments of the invention, the material, structure and shape of the choke ring 104 are not limited, and the opening H only needs to provide the effect of reducing the flow rate. The shape of the opening H, central portion H1, and expanded portion H2 is not limited to an arc shape shown in the figures, and the shape and size of the opening H, central portion H1, and expanded portion H2 may vary according to actual needs. As shown in FIG. 5A, in another embodiment, the maximum interval d2 of the expanded portion H2 can be smaller than the maximum interval d1 of the central portion H1. As shown in FIG. 5B, in another embodiment, multiple expanded portions H2 can be arranged according to the sectional flow rate distribution along the flow channel 110, and areas of respective expanded portions H2 can be the same or different. Besides, in the above embodiments, the central portion H1 may overlap a center region of the flow channel 110, and at least one bending structure N (as indicated in FIG. 5B) is formed at the junction of the central portion H1 and the expanded portion H2 to distinguish the expanded portion H2 from the central portion H1.

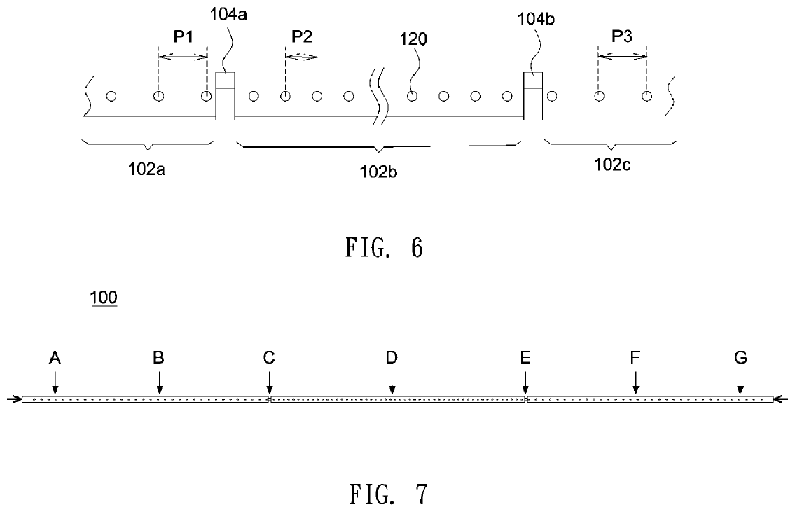

In addition, in one embodiment shown in FIG. 6, the bore holes 120 provided in sections 102a, 102b and 102c are respectively arranged with spacings P1, P2 and P3, and the spacing P2 is smaller than the first spacing P1 and the third spacing P3. Therefore, if the discharge speed of the middle section 102b decreases too much due to the use of choke rings 104a and 104b, the denser distribution (with a smaller average spacing) of bore holes 120 for the middle section 102b is allow to slightly increase the discharge speed of the middle section 102b to make the overall discharge speed more uniform.

Table 1 and Table 2 below respectively show measured discharge speed data of a conventional design without a choke ring and the embodiment shown in FIG. 2A, where the discharge speeds are measured at different positions of a flow channel (test positions A-G shown in FIG. 7) under the conditions that a fluid transport pressure is 6 KG, an inlet flow rate is 500 LPM, and lengths of sections 102a, 102b and 102c are respectively 511 mm, 528 mm and 511 mm.

TABLE 1
(conventional design)

| | Test position | | | | | | |
|---|---|---|---|---|---|---|---|
| | A | B | C | D | E | F | G |
| Speed measured at a position | 4.5 | 3.4 | 7.4 | 17.1 | 6.1 | 4.2 | 5.2 |
| of 10 cm below bore holes (m/s) | | | | | | | |
| Speed measured at a position | 3.3 | 2.5 | 4 | 11.1 | 3.8 | 2.4 | 3.2 |
| of 20 cm below bore holes (m/s) | | | | | | | |
| Speed measured at a position | 2.3 | 1.9 | 3.1 | 7.5 | 2.7 | 1.5 | 1.9 |
| of 30 cm below bore holes (m/s) | | | | | | | |

TABLE 2
(embodiment shown in FIG. 2A)

| | Test position | | | | | | |
|---|---|---|---|---|---|---|---|
| | A | B | C | D | E | F | G |
| Speed measured at | 3.24 | 2.91 | 3.52 | 4.21 | 3.41 | 2.79 | 3.38 |
| a position of 10 cm | | | | | | | |
| below bore holes | | | | | | | |
| (m/s) | | | | | | | |
| Speed measured at | 2.42 | 2.11 | 2.71 | 3.32 | 2.52 | 2.2 | 2.52 |
| a position of 20 cm | | | | | | | |
| below bore holes | | | | | | | |
| (m/s) | | | | | | | |
| Speed measured at | 1.68 | 1.46 | 1.88 | 2.34 | 1.78 | 1.41 | 1.75 |
| a position of 30 cm | | | | | | | |
| below bore holes | | | | | | | |
| (m/s) | | | | | | | |

The data shown in Tables 1 and 2 verify that the overall discharge speed of the embodiment shown in FIG. 2A is more uniform.

Table 3 and Table 4 below respectively show measured discharge speed data of a conventional design without a choke ring and the embodiment shown in FIG. 2A, where the discharge speeds are measured at different positions of a flow channel (test positions A-G shown in FIG. 7) under the conditions that a fluid transport pressure is 6 KG, an inlet flow rate is 400 LPM, and lengths of sections 102a, 102b and 102c are respectively 511 mm, 528 mm and 511 mm.

TABLE 3
(conventional design)

| | Test position | | | | | | |
|---|---|---|---|---|---|---|---|
| | A | B | C | D | E | F | G |
| Speed measured at a position | 3.1 | 3.2 | 6.4 | 10.7 | 6.5 | 3.6 | 3.6 |
| of 10 cm below bore holes (m/s) | | | | | | | |
| Speed measured at a position | 2.4 | 2.4 | 2.6 | 8.8 | 3.5 | 1.6 | 2.2 |
| of 20 cm below bore holes (m/s) | | | | | | | |
| Speed measured at a position | 1.8 | 1.5 | 1.4 | 6.6 | 2.5 | 1.2 | 1.3 |
| of 30 cm below bore holes (m/s) | | | | | | | |

TABLE 4
(embodiment shown in FIG. 2A)

| | Test position | | | | | | |
|---|---|---|---|---|---|---|---|
| | A | B | C | D | E | F | G |
| Speed measured at | 2.52 | 1.94 | 2.7 | 3.3 | 2.82 | 2.17 | 2.62 |
| a position of 10 cm | | | | | | | |
| below bore holes | | | | | | | |
| (m/s) | | | | | | | |
| Speed measured at | 1.78 | 1.25 | 1.55 | 2.32 | 1.62 | 1.28 | 1.48 |
| a position of 20 cm | | | | | | | |
| below bore holes | | | | | | | |
| (m/s) | | | | | | | |
| Speed measured at | 1.24 | 1 | 1.2 | 1.6 | 1.31 | 0.96 | 1.12 |
| a position of 30 cm | | | | | | | |
| below bore holes | | | | | | | |
| (m/s) | | | | | | | |

The data shown in Tables 3 and 4 verify that the overall discharge speed of the embodiment shown in FIG. 2A is more uniform.

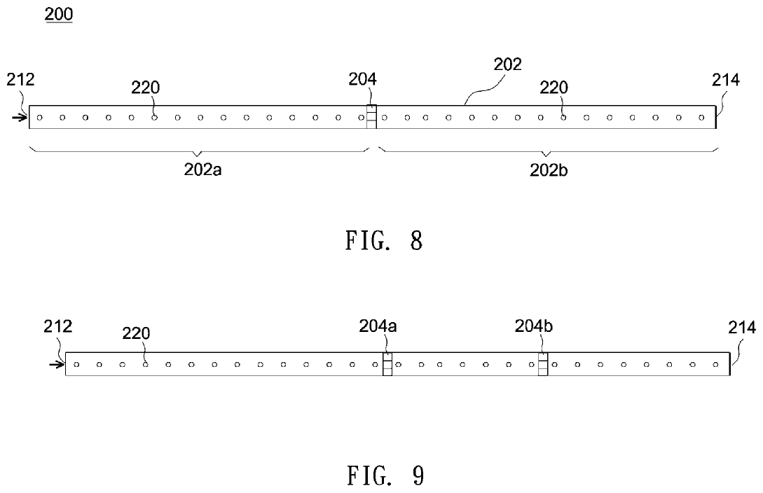

FIG. 8 shows a schematic diagram of a fluid discharge device according to another embodiment of the invention. As shown in FIG. 8, the hollow tubular body 202 of the fluid discharge device 200 includes two sections 202a and 202b, one end of the hollow tubular body 202 is a closed end 214, and the fluid enters the hollow tubular body 202 via the only one inlet 212 opposite the closed end 214 and is then released through multiple bore holes 220. Because one end of the hollow tubular body 202 is the closed end 214, the fluid discharge speed of bore holes 220 in the section 202b that is comparatively near the closed end 214 is faster than the fluid discharge speed of bore holes 220 in the section 202a. In this embodiment, a choke ring 204 connects the section 202a with the section 202b, and the choke ring 204 is allowed to reduce the flow rate when fluid flowing in the section 202a runs into the section 202b to achieve the effect of uniformly discharging fluid by the fluid discharge device 200. In various embodiments of the invention, the choke ring and the tubular body sections are not limited to specific arrangements. As shown in FIG. 9, two choke rings 204a and 204b separated by a distance are provided to gradually reduce the flow rate in succession, when the fluid is transported from the inlet 212 to the closed end 214. Besides, the opening sizes of the choke rings 204a and 204b can be adjusted to balance different fluid discharge speeds at different sections of the hollow tubular body 220; for example, the opening sizes of the choke rings 204a and 204b can be set differently to further ensure a uniform discharge speed.

According to the above embodiments, a choke ring capable of reducing the flow rate of fluid passing therethrough is used to uniform the fluid discharge amount and the discharge speed of different sections of a flow channel, and thus cause the bore holes in different positions of a fluid discharge device to release fluid at similar speeds to be suitable for use in different application environments. For example, the fluid may be a liquid or a gas. The liquid may be, for example, water, aqueous solution, a photoresist, a developer or a cleaning agent that can be used in different processes as a working fluid, and multiple bore holes of a fluid discharge device can evenly spray the liquid onto a workpiece at a uniform speed. The gas may be, for example, compressed air or inert gas, and the fluid discharge device can blow the gas out of the bore holes disposed along the entire channel at similar speeds to meet various working requirements. Moreover, in the above embodiments, the number of choke rings, shapes and sizes of holes/openings, and spacing of bore holes can be adjusted according to the required discharge speed distribution in different regions to further improve the uniformity of fluid discharge speed. Additionally, the opening of a choke ring can be provided with an expanded portion to locally adjust the flow rate and prevent excessive speed changes around the choke ring.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A fluid discharge device, comprising:
a hollow tubular body defining a flow channel, the hollow tubular body having a plurality of bore holes arranged along a longitudinal direction of the hollow tubular body, the hollow tubular body including a plurality of sections, two adjacent sections of the plurality of sections being connected by a choke ring, and the choke ring having an opening to allow a fluid to pass through, wherein, in a sectional plane perpendicular to the longitudinal direction, a sectional area of the opening is smaller than a sectional area of the flow channel.

2. The fluid discharge device as claimed in claim 1, wherein the opening comprises a central portion and at least one expanded portion extending from the central portion and towards the plurality of bore holes.

3. The fluid discharge device as claimed in claim 2, wherein a maximum interval of the at least one expanded portion is greater than a maximum interval of the central portion.

4. The fluid discharge device as claimed in claim 1, wherein the hollow tubular body includes a first section, a second section, and a third section, the second section is located between the first section and the third section, and the flow channel has two inlets at opposite ends of the hollow tubular body.

5. The fluid discharge device as claimed in claim 4, wherein a spacing between two adjacent bore holes in the second section is smaller than a spacing between two adjacent bore holes in the first section, and the spacing between two adjacent bore holes in the second section is smaller than a spacing between two adjacent bore holes in the third section.

6. The fluid discharge device as claimed in claim 1, wherein the hollow tubular body includes a first section and a second section, and the flow channel has only one inlet disposed at one end of the hollow tubular body.

7. The fluid discharge device as claimed in claim 1, wherein the fluid discharge device includes a first choke ring and a second choke ring, and an opening of the first choke ring is larger than an opening of the second choke ring.

8. The fluid discharge device as claimed in claim 1, wherein the fluid is compressed air, inert gas, water, an aqueous solution or a working fluid.

9. A fluid discharge device, comprising:
a hollow tubular body defining a flow channel, the hollow tubular body including a first section, a second section and a third section, the second section being located between the first section and the third section, and each of the first section, the second section, and the third section having a plurality of bore holes;
a first choke ring connecting the first section with the second section, and the first choke ring being capable of reducing a flow rate of a fluid when the fluid flowing in the first section runs into the second section; and
a second choke ring connecting the second section with the third section, and the second choke ring being capable of reducing a flow rate of the fluid when the fluid flowing in the third section runs into the second section.

10. The fluid discharge device as claimed in claim 9, wherein each of the first choke ring and the second choke ring has an opening to allow a fluid to pass through, and, in a sectional plane perpendicular to a longitudinal direction of the hollow tubular body, a sectional area of the opening is smaller than a sectional area of the flow channel.

11. The fluid discharge device as claimed in claim 10, wherein the opening comprises a central portion and at least one expanded portion extending from the central portion and towards the plurality of bore holes.

12. The fluid discharge device as claimed in claim 11, wherein a maximum interval of the at least one expanded portion is greater than a maximum interval of the central portion.

13. The fluid discharge device as claimed in claim 9, wherein the flow channel has two inlets at opposite ends of the hollow tubular body.

14. The fluid discharge device as claimed in claim 9, wherein a spacing between two adjacent bore holes in the second section is smaller than a spacing between two adjacent bore holes in the first section, and the spacing between two adjacent bore holes in the second section is smaller than a spacing between two adjacent bore holes in the third section.

15. The fluid discharge device as claimed in claim 9, wherein the fluid is compressed air, inert gas, water, aqueous solution or a working fluid.
